(19) United States
(12) Patent Application Publication
(10) Pub. No.: US 2007/0102062 A1
(43) Pub. Date: May 10, 2007

(54) Drum flaker and knife therefor

(76) Inventors: Bradley R. Stager, Beaverton, OR (US); Jianmin Liao, Tigard, OR (US); Joseph B. Bielagus, Tualatin, OR (US)

Correspondence Address: Garth Janke;BIRDWELL & JANKE LLP, Suite 1400, 1100 SW Sixth Avenue, Portland, OR, 97204, US

(21) Appl. No.: 11/269,396

(22) Filed: Nov. 7, 2005

(51) Int. Cl. B27G 13/00; B27C 1/00; B27C 5/00

(52) U.S. Cl. 144/241; 144/218; 144/220

(57) ABSTRACT

A drum flaker and knife therefor. A drum flaker comprises a drum for turning about an axis of revolution, a plurality of knife assemblies mounted to the drum, and a plurality of knives for mounting in the knife assemblies. The knives each have an elongate axis and comprise, on a first cutting side of the knife, at least two sets of cutting edges. The cutting edges of one of the sets alternate with and are radially offset from corresponding and respective cutting edges of the other of the sets.

### FIELD OF THE INVENTION

The present invention relates to a drum flaker and knife therefor, particularly for producing flakes of substantially uniform dimensions from logs.

### BACKGROUND

Drum flakers are a class of wood chipping or wood processing machines variously referred to as flakers or stranders, that produce flakes, elongate wafers, or strands (all hereinafter “flakes”) from logs or other articles of wood for use in manufactured board products such as particle board, oriented strand board, and fiberboard. Ring slicers also fall within this class. Functionally, the drum flaker is distinguished from the ring flaker in that the former is particularly adapted to produce flakes of substantially uniform dimensions, while the ring flaker produces flakes in a wide range of dimensional variability.

The drum flaker comprises a cylindrical drum on a shaft for rotation about the cylindrical axis of the drum. The drum carries on its periphery a number of elongate, parallel knife assemblies.

FIGS. 1 and 2 show a drum 1 on a shaft 2 for rotation about an axis “R.” Typically, a plurality of logs 3 are clamped or held as a group (clamping not shown) so that the elongate axes of the logs are aligned with the axis of rotation of the drum. The logs are carried into contact with the spinning drum in the direction indicated by the arrows, and particularly into contact with the knives carried by the drum, as flakes are removed from the logs.

FIG. 3 shows a prior art drum flaker 15 in more detail. Parallel knives 4 are angled, relative to the axis of rotation, at a shallow “slice angle” with their cutting edges facing in the direction of rotation of the drum. Each knife has an associated knife assembly that clamps the knife in place. FIG. 4 shows a detailed, perspective view of one of the knife assemblies 5 of the prior art flaker.

The knife assembly 5 fits into a pocket 5a in the drum 1. The knife assembly 5 includes one of the knives 4, e.g., 4a, a back-side knife support member 6 for supporting a back side of the knife, a front-side knife support member 7 for supporting a front side of the knife, and a wedging member 8 which, primarily as a result of centrifugal force, wedges against the front-side knife support member 7 to clamp the knife 4a between the front-side knife support member and the back-side knife support member 6. The knife assembly 5 also includes retaining blocks. 9 and 10 behind the back and front-side knife support members, for retaining the back and front-side knife support members in the pocket 5a when the drum is stopped and there is no centrifugal force.

FIGS. 5 and 6 show the knife 4a in detail. The knife 4a has a plurality of cutting members 11a having cutting edges 12 spaced apart from one another. The cutting edges are defined by the intersection of a ramping plane “P1” and a plane “P2” defining a front side of the knife, the planes P1 and P2 defining an acute “knife angle” μ. The cutting edges lie along a line, the line being inclined with respect to the axis of rotation of the drum (see also FIG. 3) by a slice angle θ. The slice angle θ is typically in the range 5<θ<15 degrees.

The length “L” of the cutting member and the cutting edge is equal to and defines the length of the flake to be produced. A typical length of a flake may be 1″. Returning to FIG. 4, a predetermined “knife extension” distance “D1” determines the width of the flake. A typical flake width may be ¼″. The thickness of the flake is determined by a combination of the spacing of the next corresponding cutting edge of an adjacent knife, the speed of the periphery of the drum, and the speed of travel of the logs toward the drum. A typical flake thickness may be 0.020″.

Returning to FIGS. 5 and 6, situated between the cutting members 11a are relief regions 13a. The relief regions include planes “P3” set back a distance “D2” from the elevation of the cutting edges 12. The planes P3 are bounded by and perpendicular to the front side plane P2. The relief regions have no cutting edges, because the edges “E” defined by the intersection of the planes P3 and the plane P2 are at 90 degrees, i.e., they do not form an acute knife angle. In addition, the distance D2 is sufficiently large that these edges do not come into contact with the logs.

As shown, the cutting members of a knife 4 are periodically spaced, the cutting members of each of the knives alternating with relief regions of substantially the same axial width.

Turning to FIG. 7, the knives are axially aligned so that the relief regions of the knife 4a cooperate with cutting regions 11b of an adjacent knife 4b. Particularly, the relief regions 13a of the knife 4a are axially aligned (along drum rotation axis R) with the cutting members 11b of the knife 4b. Similarly, the cutting members 11a of the knife 4a are axially aligned with the relief regions 13b of the knife 4b. FIG. 8 shows cuts 14a and 14b produced, respectively, by the knives 4a and 4b of the drum 1 in the side of a log 3a. The cuts 14a and 14b are radially offset from one another with respect to the axis “L” of the log (or the axis “R” of the drum), where the offset reflects the delay, from the time the knife 4a makes contact with the log, to the time the knife 4b makes contact with the log as a result of movement of the log in the direction indicated in FIG. 2.

As for all wood chipping machines, knives wear quickly and need to be replaced frequently during use of the machines. For a given amount of processing performed by the machine, the time the machine is down for knife replacement or repair represents a significant loss in throughput and revenue. Thus, as for all wood processing machines, there is a need for a drum flaker and knife therefor that decrease this down-time, relative to the quantity of flakes produced.

### SUMMARY

A drum flaker and knife therefor. The drum flaker comprises a drum for turning about an axis of revolution, a plurality of knife assemblies mounted to the drum, and a plurality of knives for mounting in the knife assemblies. Preferably, cutting edges of the knives are inclined with respect to the axis of revolution of the drum by a slice angle θ in the range 5<θ<15 degrees. The knife assemblies preferably include respective counterknives employed as clamping members for the knives.

Knives according to the invention each have an elongate axis and comprise, on a first cutting side of the knife, at least two sets of cutting edges. The cutting edges of one of the sets alternate with and are radially offset from corresponding and respective cutting edges of the other of the sets.

Preferably, the cutting edges are defined by intersecting planar surfaces forming acute knife angles μ in the range 27<μ<35 degrees, the knife includes mating features for indexing the knife to one or more clamping members for clamping the knife, and the knife is double-sided.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 a plan view of a drum flaker for processing a plurality of logs.

FIG. 2 is a side view of the drum flaker and logs of FIG. 1.

FIG. 3 is a pictorial view of a particular prior art drum flaker having a plurality of knife assemblies.

FIG. 4 is a pictorial detailed view of one of the knife assemblies of FIG. 3.

FIG. 5 is a side elevation of a knife corresponding to one of the knife assemblies of FIG. 4.

FIG. 6 is a cross-sectional view of a cutting member of the knife of FIG. 5, taken along a line 6-6 thereof.

FIG. 7 is a side elevation comparing the knife of FIG. 5 to an adjacent knife of the drum flaker of FIG. 3.

FIG. 8 shows a series of cuts produced on a log by the knives of FIG. 7.

FIG. 9 is a pictorial view of a preferred knife 20 according to the present invention.

FIG. 10 is a back side view of the knife of FIG. 9.

FIG. 11 is a pictorial illustration of a series of cuts produced on a log by the knife of FIG. 9.

FIG. 12 is a side elevation of the knife of FIG. 9 looking down the axis “EA.”

FIG. 13 is a cross-sectional view of a knife assembly according to the present invention.

FIG. 14 shows the knife assembly of FIG. 13 in side elevation.

FIG. 15 is a pictorial view of an alternative knife assembly according to the present invention, including scoring knives.

FIG. 16 shows the knife assembly of FIG. 15 in side elevation.

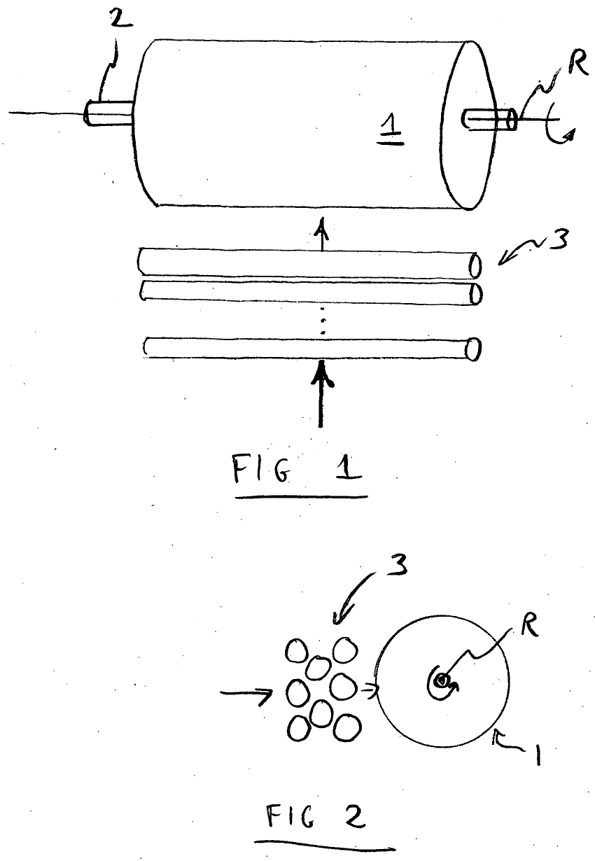

### DETAILED DESCRIPTION OF PREFERRED EMBODIMENTS

Reference will now be made in detail to specific preferred embodiments of the invention, examples of which are illustrated in the accompanying drawings. Wherever possible, the same reference numbers are used in the drawings and the description to refer to the same or like parts or dimensions.

The present inventors have had a number of recognitions in connection with the drum flaker described above. In each of the knives 4 described above, cutting edges alternate with relief regions of substantially the same axial width, only about 50% of the length of each knife is available for cutting. However, the knife will need to be repaired, e.g., by grinding, or replaced, at a frequency depending on how much each cutting edge wears. For a given knife, more wood can be cut by providing more cutting edges, but each cutting edge will suffer the same amount of wear. Therefore, increasing the number of cutting edges permits the knife to cut more wood but does not require that the knife be removed from the machine with any greater frequency. Thus, increasing the number of cutting edges results in a commensurately increased wood-cutting efficiency.

On the other hand, the aforedescribed knives 4 provide the relief regions 13 so that the knives produce flakes of uniform dimensions. The present invention provides a novel knife for use in a drum flaker that improves the wood-cutting efficiency of each knife of a drum flaker while still meeting this objective.

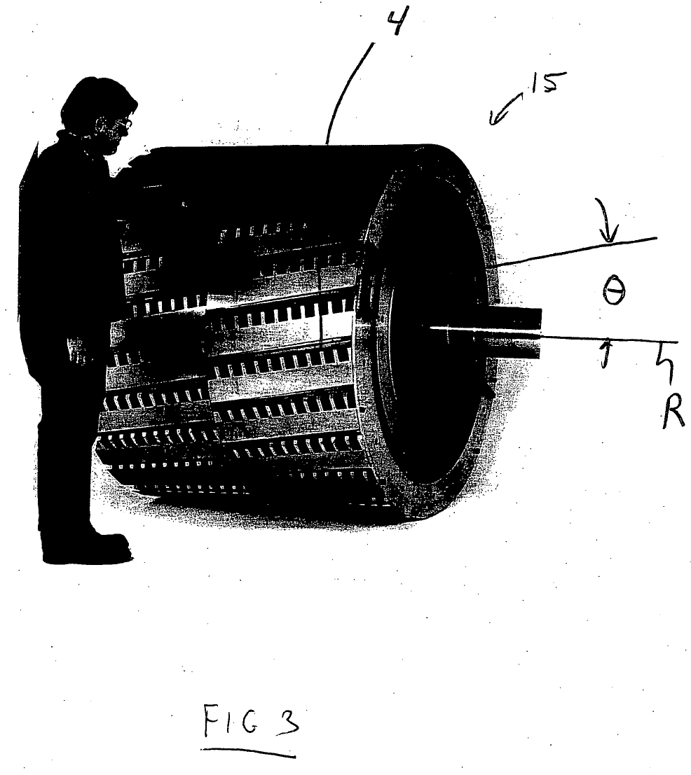

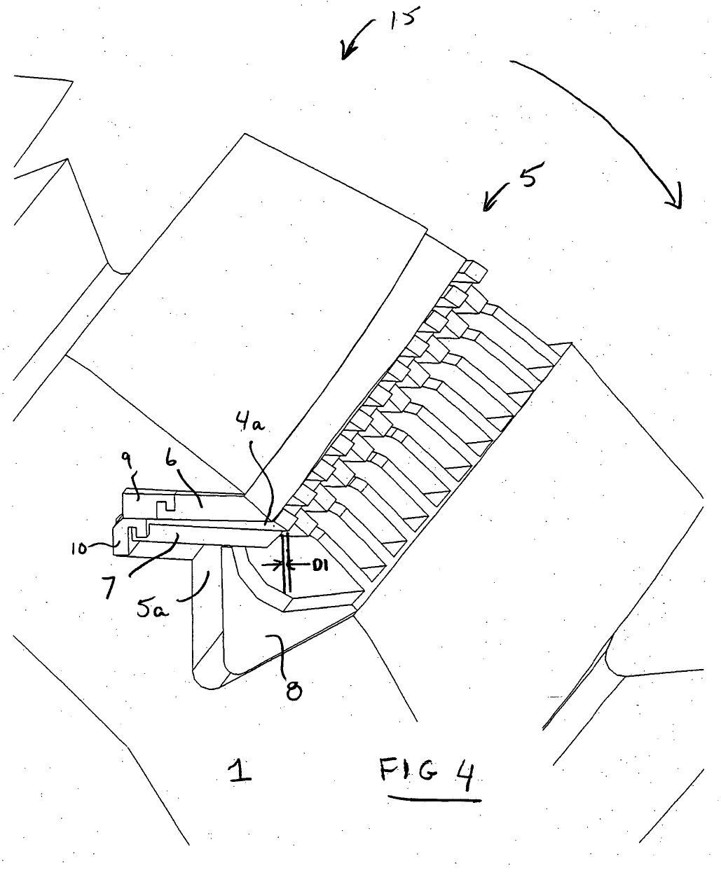

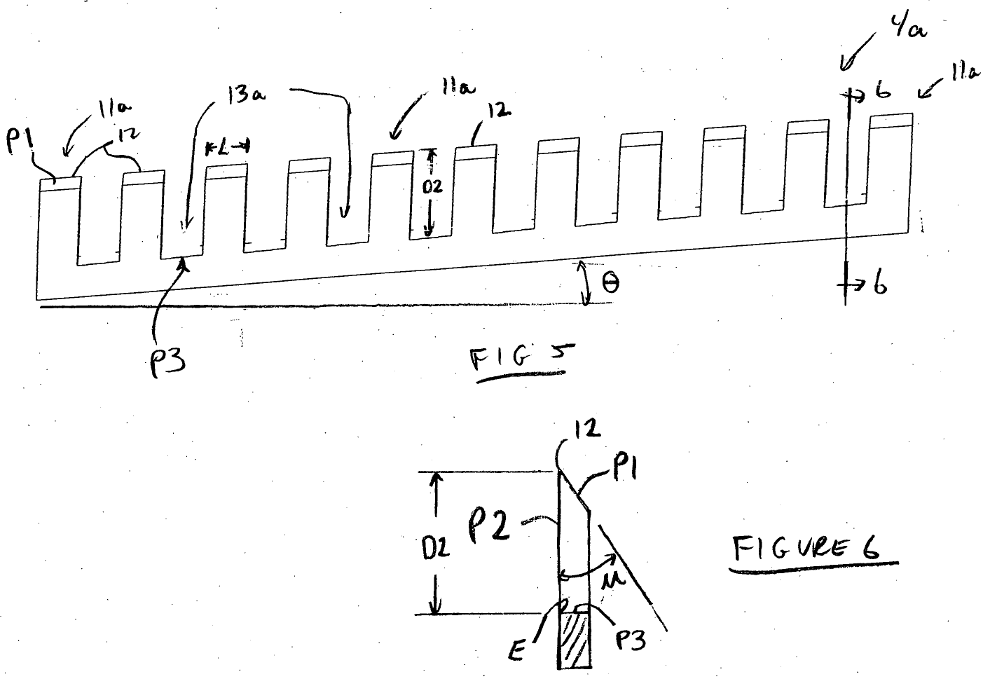

FIG. 9 is a pictorial view of a preferred knife 20 according to the present invention. FIG. 13 shows the knife 20 mounted in a drum 39. The drum 39 may be similar or identical to the drum 2 of FIG. 3. Preferably it is identical, to provide for maximum utilization of existing parts; however, knives and knife assemblies according to the present invention may be used in alternative wood processing machines without departing from its principles.

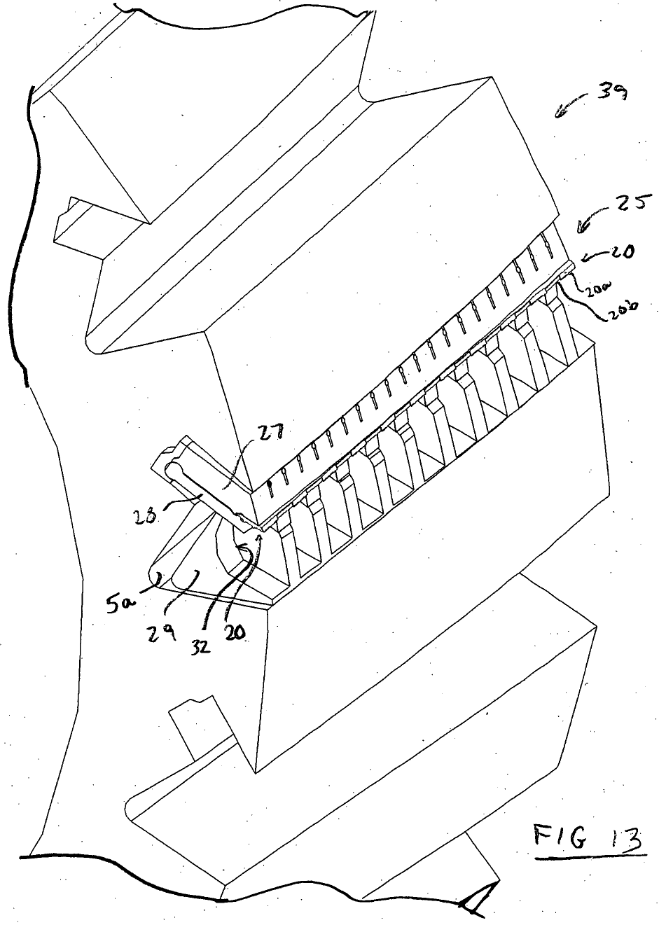

On at least one side of the knife 20, without limitation or exclusion, the knife includes a first series or “set” of cutting edges 20a and a second set of cutting edges 20b. In the preferred embodiment, there are a plurality of cutting edges in each set, and the cutting edges of both of these sets are all parallel to each other and to the elongate axis “EA” of the knife; however, none of these conditions is essential. With additional reference to FIG. 12, each cutting edge is defined by the meeting of two planes, one plane P4 being part of a front (“FRONT”) side of the knife which faces in the direction of rotation of the drum and which is on the underside of the knife as it is seen in FIG. 9. Planes P5a and P5b form acute knife angles μ with respect to the plane P4 to define, respectively, the cutting edges 20a and 20b. Each knife angle μ is preferably in the range 27<μ<35 degrees.

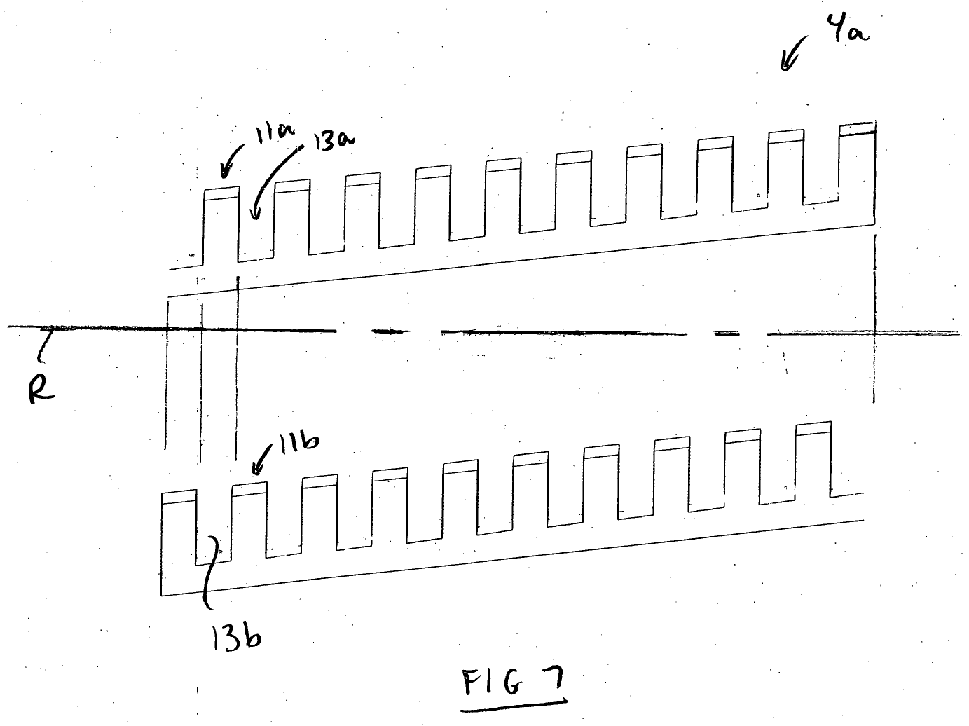

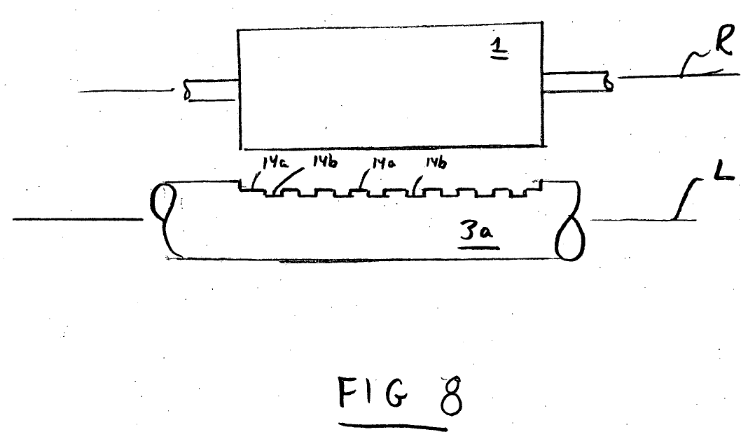

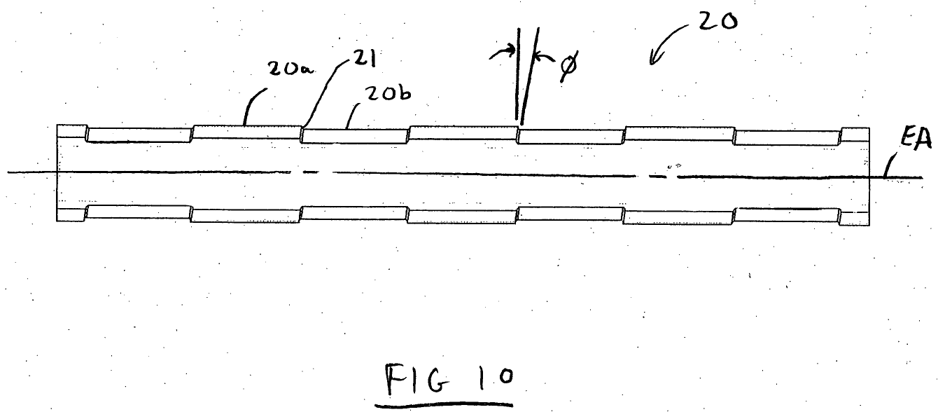

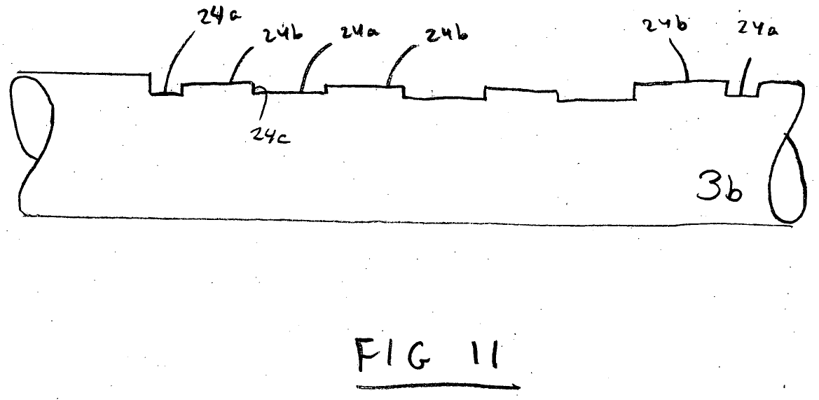

With reference to FIGS. 9 and 10, each cutting edge 20a is separated from but connected to an adjacent cutting edge 20b by a corresponding connecting edge 21 that is angled at an angle φ with respect to the elongate axis “EA” of the knife 20. As in the prior art shown in FIG. 5, the knife is mounted to the drum so that the elongate axis “EA” is set at an angle θ with respect to the axis (and direction) of rotation of the drum. Preferably, the angle φ is equal to the angle θ, so that the connecting edges 21 are oriented perpendicular to the axis of rotation.

It is an outstanding advantage of the knife 20 that the cutting edges 20a and 20b are closely spaced together axially in the direction of the elongate axis “EA” so that, essentially, the entire length of the knife includes the cutting edges of one series or the other. This provides the outstanding advantage of essentially doubling the wood-cutting efficiency of the knife as compared to the prior art knife 4.

The cutting edges 20a are radially offset from adjacent corresponding cutting edges 20b with respect to the elongate axis a distance “t” (FIGS. 9 and 12 both drawn substantially to scale). This dimension may be used to define the flake thickness in an apparatus in which feed control is not reliable or precise, such as in a self-feeding apparatus. So, for example, the dimension may be “0.020” to define a flake of the same thickness. Alternatively, in an apparatus in which feed is well controlled, the dimension “t” may be made larger than the flake thickness where the flake thickness is defined instead by the spacing of the knives, the speed of the periphery of the drum and the speed of the feed. Using this latter strategy, adjusting the feed provides a range of adjustable flake thicknesses.

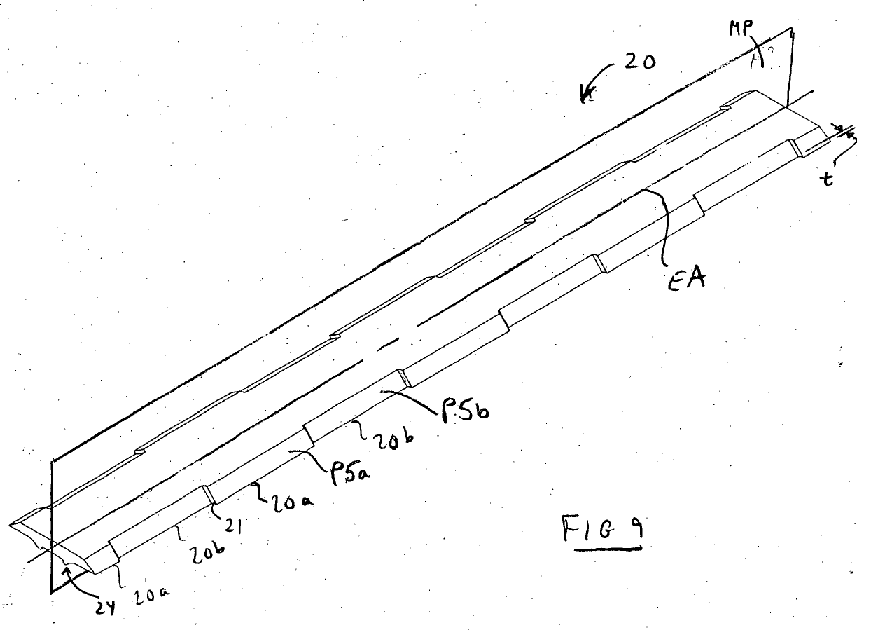

The radial offset “t” is relatively small compared to the distance that the cantilevered cutting members of the prior art knife 4 project (see FIG. 7, drawn substantially to scale). Therefore, with the comparatively small cantilever supporting the cutting edges 20a, the knife 20 provides much greater strength and robustness than the prior art knife.

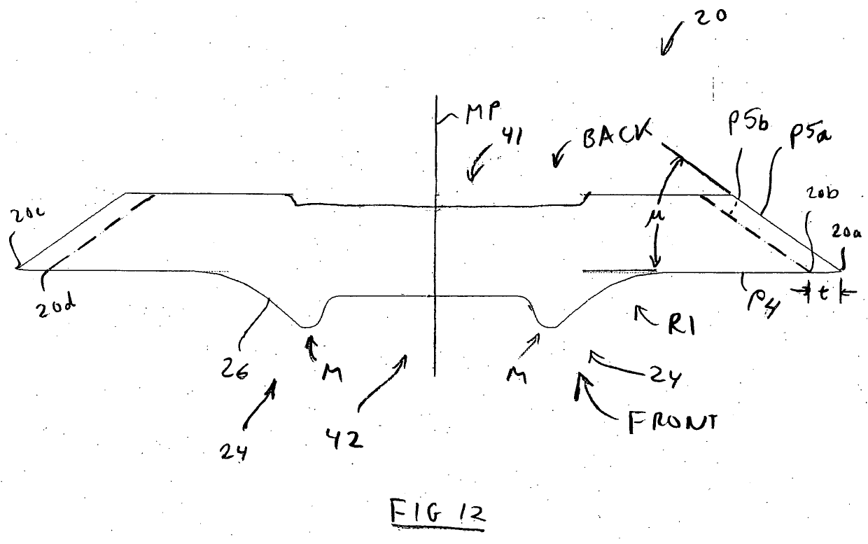

FIG. 11 shows cuts 24a and 24b produced, respectively, by the cutting edges 20a and 20b of the knife 20 in a log 3b. This result may be compared directly with the cuts 14a and 14b of FIG. 8 produced by the two knives 4a and 4b. The result is essentially or identically the same, providing the outstanding advantage that a single knife 20 substitutes for two prior art knives 4a and 4b.

The cuts 24a and 24b are connected by segments 24c resulting from contact with the connecting edges 21 of the knife 20. While the connecting edges 21 are preferably maintained in a condition of sharpness, so that the knife has a continuous cutting edge and the segments 24c are cut cleanly thereby, it should be understood that this is not essential, as the segments are of minimal length. This is especially true where the angle φ is equal to the angle θ as mentioned above.

The knife 20 is also preferably double-sided, in which case it has cutting edges on both sides of the elongate axis. Further, preferably, the knife is symmetric about a centrally located mirror plane “MP,” and has cutting edges 20c and 20d corresponding to and constructed like the cutting edges 20a and 20b, respectively. As a result of having this symmetry, the knife may be removed from the drum, turned end-for-end, and replaced to provide fresh cutting edges.

Referring to FIG. 13, each knife 20 is associated with a corresponding knife assembly 25, that may be mounted in a pocket 5a of the drum 39. A knife assembly 25 includes a knife 20, a clamp 27 for supporting the BACK side of the knife, and a counter-knife 28 for supporting the FRONT side of the knife. These parts may be wedged in place as in the prior art drum flaker by a wedging member 29, or may be clamped to the drum. Where the wedging member 29 is used, it preferably incorporates a curved “gullet” region 32 shaped for smoothly and as slowly as possible changing the direction of flakes cut by the knife and received by the gullet, to efficiently exhaust the flakes out and away from the flaker. The knife is also shaped in a region “R1” (best seen in FIG. 12) to assist in this regard as described below, alone or in combination with a gullet.

Particularly, referring back to FIGS. 9 and 12, the FRONT side of the knife 20, while otherwise substantially planar, includes non-planar features serving two purposes. Preferably, the features are, for a double-sided knife 20, a pair of spaced apart “deflector ridges” 24 that extend outwardly from the FRONT of the knife, running parallel to the elongate axis “EA.” Such deflector ridges are described in Schmatjen, U.S. Pat. No.5,819,826, incorporated by reference herein in its entirety. The deflector ridges each have concavely curved outer side surfaces 26 projecting from the FRONT side to points of maximal projection “M.” The points of maximal projection may reside in gently curved surfaces as shown, or the deflector ridges may terminate in substantially sharp edges. The deflector ridges provide for a smooth transition for guiding the flow of flakes, and they also define a FRONT-side recess 42 therebetween that can be used to index and positively hold the knife 20 to the counterknife 28 in a stable position. Either of these advantages could be provided by alternative features. For example, to provide for indexing, the non-planar feature could be any projection or depression for mating to a complementary non-planar feature in the counterknife, and an equivalent of the recess 42 could be provided by a keyway. To provide for smooth flow of flakes, many different curved surfaces could be used.

The knife 20 may also include a truncated “V” shaped BACK-side recess 41 that is used to index the knife to the clamp 27, to even more positively hold the knife in place. Preferably, the knife is clamped between the clamp 27 and the counterknife 28 by clamping bolts 30, which may extend into the drum to clamp these parts to the drum if no wedging member is used.

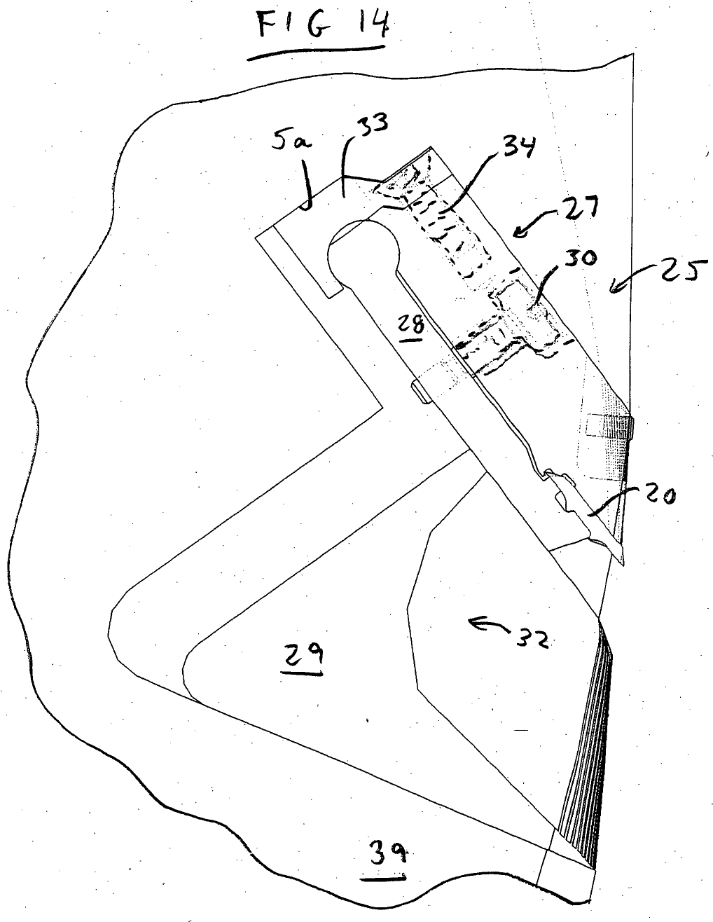

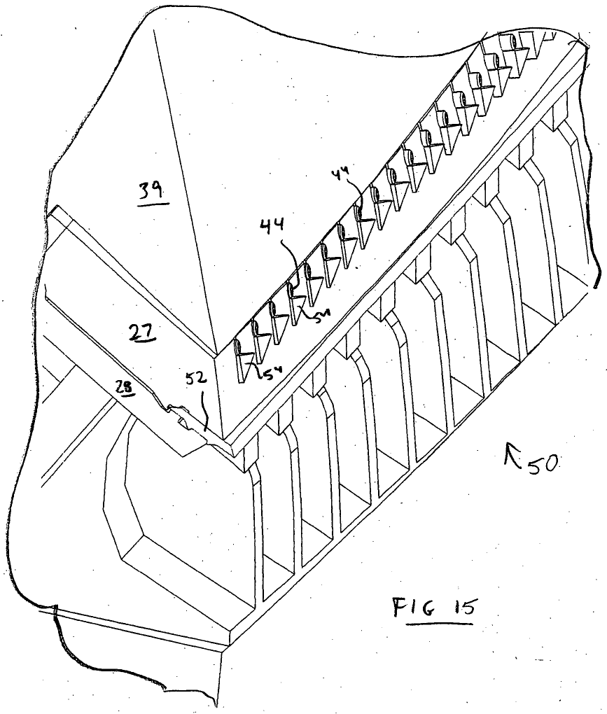

FIG. 14 shows the knife assembly 25 of FIG. 13 in side elevation. The knife assembly may include a filler block 33 for filling remaining space in the pocket 5a and, preferably, providing additional means of securing the clamp 27 and counterknife 28, e.g., by additional bolts 34 extending through the filler block into the clamp, and by being interlockingly shaped with the clamp and counterknife such as shown.

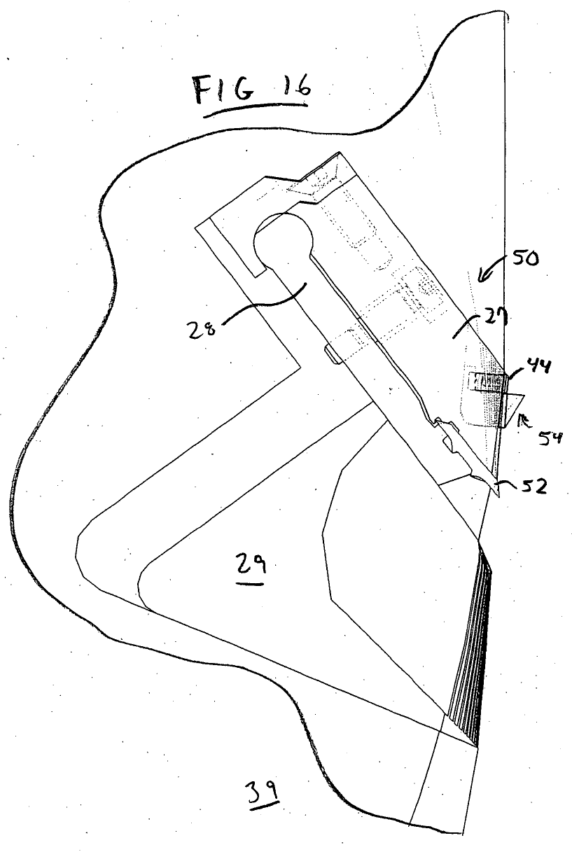

FIG. 15 illustrates an alternative to providing knives 20 having staggered cutting edges as described above to meet the objective of producing a high percentage of flakes having desired target dimensions. That is, a knife assembly 50 may be provided employing stranding knives 52 that are of the standard configuration for use in ring slicers, i.e., characterized by having, on at least one side of the knife, a single, unbroken cutting edge running the entire length of the knife, and the flakes are cut to length by spaced apart scoring knives 54 having cutting edges oriented perpendicular to the cutting edges of the stranding knives. A preferred stranding knife 50 in such a drum flaker is double-sided and, apart from the cutting edges, is the same as the knife 20 as shown in FIGS. 9 and 12. The scoring knives 54 are preferably individually mounted to the clamp 27, by use of associated bolts 44; however, they may be supported by other structures including the drum. An advantage of using the scoring knives is that a knife having a single, unbroken cutting edge is easier to repair than a knife having staggered cutting edges. A disadvantage, however, of the use of scoring knives is that additional parts are required and need to be maintained. FIG. 16 shows the knife assembly 50 of FIG. 15 in side elevation.

It is to be understood that, while a specific drum flaker and knife therefor has been shown and described as preferred, other configurations and methods could be utilized, in addition to those already mentioned, without departing from the principles of the invention. It should also be understood that while the preferred knives are especially adapted for a drum flaker for producing flakes from logs or other articles of wood, knives according to the invention may be used in other cutting apparatus, e.g., having drum and disk cutting heads, for cutting wood or other materials.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A knife having an elongate axis and comprising, on a first cutting side of the knife, at least two first sets of cutting edges, the cutting edges of one of said first sets alternating with and radially offset from corresponding and respective cutting edges of the other of said first sets.

2. The knife of claim 1, wherein the cutting edges associated with one of said first sets of cutting edges are all parallel to each other, and wherein the cutting edges associated with the other of said first sets of cutting edges are all parallel to each other.

3. The knife of claim 2, wherein the cutting edges of both said first sets of cutting edges are all parallel to each other.

4. The knife of claim 2, wherein the cutting edges associated with one of said first sets of cutting edges are all co-linear, and wherein the cutting edges associated with the other of said first sets of cutting edges area all co-linear.

5. The knife of claim 4, wherein the cutting edges of said first sets of cutting edges are all parallel to each other.

6. The knife of claim 5, wherein the cutting edges of said first sets of cutting edges are all defined by intersecting planar surfaces forming acute knife angles μ in the range 27<μ<35 degrees.

7. The knife of claim 4, wherein the cutting edges of said first sets of cutting edges are all defined by intersecting planar surfaces forming acute knife angles μ in the range 27<μ<35 degrees.

8. The knife of claim 3, wherein the cutting edges of said first sets of cutting edges are all defined by intersecting planar surfaces forming acute knife angles μ in the range 27<μ<35 degrees.

9. The knife of claim 2, wherein the cutting edges of said first sets of cutting edges are all defined by intersecting planar surfaces forming acute knife angles μ in the range 27<μ<35 degrees.

10. The knife of claim 1, wherein the cutting edges of said first sets of cutting edges are all defined by intersecting planar surfaces forming acute knife angles μ in the range 27<μ<35 degrees.

11. The knife of claim 1, further comprising, on a second cutting side of the knife opposite said first side, at least two second sets of cutting edges, the cutting edges of one of said second sets alternating with and radially offset from corresponding and respective cutting edges of the other of said second sets.

12. The knife of claim 11, wherein the cutting edges associated with one of said first sets of cutting edges are all parallel to each other, wherein the cutting edges associated with the other of said first sets of cutting edges are all parallel to each other, wherein the cutting edges associated with one of said second sets of cutting edges are all parallel to each other, and wherein the cutting edges associated with the other of said second sets of cutting edges are all parallel to each other.

13. The knife of claim 12, wherein the cutting edges of said first sets of cutting edges and said second sets of cutting edges are all parallel to each other.

14. The knife of claim 12, wherein the cutting edges associated with one of said first sets of cutting edges are all co-linear, wherein the cutting edges associated with the other of said first sets of cutting edges area all co-linear, wherein the cutting edges associated with one of said second sets of cutting edges are all co-linear, and wherein the cutting edges associated with the other of said second sets of cutting edges area all co-linear.

15. The knife of claim 14, wherein the cutting edges of said first sets of cutting edges and said second sets of cutting edges are all parallel to each other.

16. The knife of claim 15, wherein the cutting edges of said first sets of cutting edges are mirror images of the cutting edges of said second sets of cutting edges with respect to a mirror plane passing through said elongate axis.

17. The knife of claim 16, wherein the cutting edges of said first sets of cutting edges and said second sets of cutting edges are all defined by intersecting planar surfaces forming acute knife angles μ in the range 27<μ<35 degrees.

18. The knife of claim 15, wherein the cutting edges of said first sets of cutting edges and said second sets of cutting edges are all defined by intersecting planar surfaces forming acute knife angles μ in the range 27<μ<35 degrees.

19. The knife of claim 14, wherein the cutting edges of said first sets of cutting edges and said second sets of cutting edges are all defined by intersecting planar surfaces forming acute knife angles μ in the range 27<μ<35 degrees.

20. The knife of claim 13, wherein the cutting edges of said first sets of cutting edges and said second sets of cutting edges are all defined by intersecting planar surfaces forming acute knife angles μ in the range 27<μ<35 degrees.

21. The knife of claim 12, wherein the cutting edges of said first sets of cutting edges and said second sets of cutting edges are all defined by intersecting planar surfaces forming acute knife angles μ in the range 27<μ<35 degrees.

22. The knife of claim 11, wherein the cutting edges of said first sets of cutting edges and said second sets of cutting edges are all defined by intersecting planar surfaces forming acute knife angles μ in the range 27<μ<35 degrees.

23. The knife of claim 22, defining a substantially planar front side and a back side spaced from said front side and having planes intersecting said front side defining said cutting edges, said front side and said planes defining said knife angles μ, said front side having at least one non-planar mating feature, for indexing the knife to a clamping member for clamping the knife.

24. The knife of claim 23, wherein said mating feature comprises at least one projection extending parallel to the elongate axis of the knife.

25. The knife of claim 24, wherein said projection is a deflector ridge.

26. The knife of claim 24, wherein said mating feature comprises at least two spaced apart deflector ridges extending parallel to the elongate axis of the knife.

27. A drum flaker, comprising:
a drum for turning about an axis of revolution;
a plurality of knife assemblies mounted to said drum; and
a plurality of respective knives for mounting in said knife assemblies, each of said knives having an elongate axis and comprising, on a first cutting side of the knife, at least two first sets of cutting edges, the cutting edges of one of said first sets alternating with and radially offset from corresponding and respective cutting edges of the other of said first sets.

28. The drum flaker of claim 27, wherein for the knives as mounted on the drum flaker, said cutting edges are angled with respect to the axis of rotation of the drum by a slice angle θ in the range 5<θ<15 degrees.

29. The drum flaker of 28, wherein the cutting edges associated with one of said first sets of cutting edges are all parallel to each other, and wherein the cutting edges associated with the other of said first sets of cutting edges are all parallel to each other.

30. The drum flaker of claim 29, wherein the cutting edges of both said first sets of cutting edges are all parallel to each other.

31. The drum flaker of claim 29, wherein the cutting edges associated with one of said first sets of cutting edges are all co-linear, and wherein the cutting edges associated with the other of said first sets of cutting edges area all co-linear.

32. The drum flaker of claim 31, wherein the cutting edges of said first sets of cutting edges are all parallel to each other.

33. The drum flaker of claim 32, wherein the cutting edges of said first sets of cutting edges are all defined by intersecting planar surfaces forming acute knife angles μ in the range 27<μ<35 degrees.

34. The drum flaker of claim 31, wherein the cutting edges of said first sets of cutting edges are all defined by intersecting planar surfaces forming acute knife angles μ in the range 27<μ<35 degrees.

35. The drum flaker of claim 30, wherein the cutting edges of said first sets of cutting edges are all defined by intersecting planar surfaces forming acute knife angles μ in the range 27<μ<35 degrees.

36. The drum flaker of claim 29 wherein the cutting edges of said first sets of cutting edges are all defined by intersecting planar surfaces forming acute knife angles μ in the range 27<μ<35 degrees.

37. The drum flaker of claim 28, wherein the cutting edges of said first sets of cutting edges are all defined by intersecting planar surfaces forming acute knife angles μ in the range 27<μ<35 degrees.

38. The drum flaker of claim 27, wherein the cutting edges of said first sets of cutting edges are all defined by intersecting planar surfaces forming acute knife angles μ in the range 27<μ<35 degrees.
